(19) United States
(12) Patent Application Publication
(10) Pub. No.: US 2009/0021387 A1
(43) Pub. Date: Jan. 22, 2009

(54) Input display apparatus and mobile radio terminal

(75) Inventor: Masafumi Hosono, Kunitachi-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/069,109

(22) Filed: Feb. 7, 2008

(30) Foreign Application Priority Data
Jul. 20, 2007 (JP) 2007-190109

(51) Int. Cl. G09G 5/00; H04M 1/00

(52) U.S. Cl. 340/686.1; 345/156; 455/566

(57) ABSTRACT

When a user brings a finger thereof or the like close to a display unit, a touch-screen input unit detects the finger or the like, and the control unit displays a pointer indicating a position to be accepted, on the display unit to show the pointer to the user. If the finger or the like contacts the touch-screen input unit after the pointer is displayed, the control unit executes a process corresponding to the object closest to the pointer.

### CROSS-REFERENCE TO RELATED APPLICATIONS

This application is based upon and claims the benefit of priority from prior Japanese Patent Application No. 2007-190109, filed Jul. 20, 2007, the entire contents of which are incorporated herein by reference.

### BACKGROUND OF THE INVENTION

1. Field of the Invention

The present invention relates to an input display apparatus having an input device and a display device integrated.

2. Description of the Related Art

Recently, a portable information device such as a cellular telephone, PDA (Personal Digital Assistants) or the like has been equipped with a display device having a high-definition display ability, to display a large amount of information at a time. In addition, the information portable terminal also has been equipped with a function such as Web browsing, with convenience of the same level as a personal computer (cf., for example, white paper on information communications, 2007 edition, page 156, (4) Networking and Functionality of Portable Information Communication Terminals).

However, since a portable information device is required to be downsized and lightweight for portability, it hardly comprises a keyboard and a large display unit such as those provided on a personal computer and has less convenience than a personal computer in terms of inputting.

The conventional portable information device comprises a display unit having a high-definition display ability but has a problem that it has little convenience in terms of inputting.

### BRIEF SUMMARY OF THE INVENTION

The present invention has been accomplished to solve the above-described problems. The object of the present invention is to provide an input display apparatus and a mobile radio terminal, with improved convenience of inputting.

To achieve this object, an aspect of the present invention is configured to comprise: a display unit which displays information; a detection unit provided in a display area of the display unit to detect a position of an object brought close to the apparatus in an non-contact fashion, in the display area; and a display control unit which displays information at a position based on the position detected by the detection unit, in the display area of the display unit.

As described above, the position of the article which is made to be close by non-contact, on a display area, is detected by the detection unit provided on the display area of the display unit, and the information is displayed at the position based on the position detected by the detection unit, in the display area of the display unit.

Therefore, since the position pointed by the user is displayed on the display unit before inputting, the user can execute inputting at a desired position and the convenience of inputting can be enhanced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a mobile radio terminal according to first and second embodiments of the present invention;

FIG. 2 is an illustration showing an outer appearance of the mobile radio terminal shown in FIG. 1;

FIG. 3 is a flowchart showing operations of the mobile radio terminal according to the first embodiment;

FIG. 4 is an illustration showing a screen display for operations of the mobile radio terminal according to the first embodiment;

FIG. 5 is an illustration showing a screen display for operations of the mobile radio terminal according to the first embodiment;

FIG. 6 is a flowchart showing operations of the mobile radio terminal according to a second embodiment;

FIG. 7 is an illustration showing a screen display for operations of the mobile radio terminal according to the second embodiment; and

FIG. 8 is an illustration showing a screen display for operations of the mobile radio terminal according to the first embodiment.

### DETAILED DESCRIPTION OF THE INVENTION

Embodiments of the present invention will be described with reference to the accompanying drawings. In the following descriptions, a cellular telephone (mobile radio terminal) is employed as a portable information device equipped with an input display apparatus according to the present invention.

FIG. 1 is a block diagram showing a configuration of a mobile radio terminal according to a first embodiment of the present invention.

The mobile radio terminal of the present invention comprises, as its main constituent elements, a control unit 100, a radio communications unit 10, a conversation unit 20, an operation unit 30, a display unit 40, a touch-screen input unit 50, and a memory unit 60 as shown in FIG. 1.

The radio communications unit 10 establishes radio communications with a base station apparatus BS accommodated in a mobile communications network NW, under instructions of the control unit 100.

The conversation unit 20 comprises a speaker 21 and a microphone 22 to convert user's speech input through the microphone 22 into speech data and output the speech data to the control unit 100, and to decode speech data received from a conversation partner or the like and output the decoded speech data from the speaker 21.

The operation unit 30 is composed of a plurality of key switches such as ten-key and the like to accept the input of numbers, letters and characters, the user's requests and the like.

The display unit 40 displays images (still images and moving images), letter and character information and the like to visually transmit the information to the user, under instructions of the control unit 100.

The touch-screen input unit 50 is mounted on a display face of the display unit 40 to detect coordinates of a point to which the user brings a finger thereof or a stylus close in a non-contact fashion (hereinafter called non-contact input unit coordinates) and coordinates of a point which the user makes a finger or a stylus contact (hereinafter called contact input unit coordinates), and notify the control unit 100 of the input information in which the detected coordinates (non-contact input unit coordinates or contact input unit coordinates) are associated with information indicating the contact/non-contact. A sensor unit of the touch-screen input unit 50 mounted on the display face of the display unit 40 is formed of a translucent material which makes the information displayed on the display unit 40 visually recognizable.

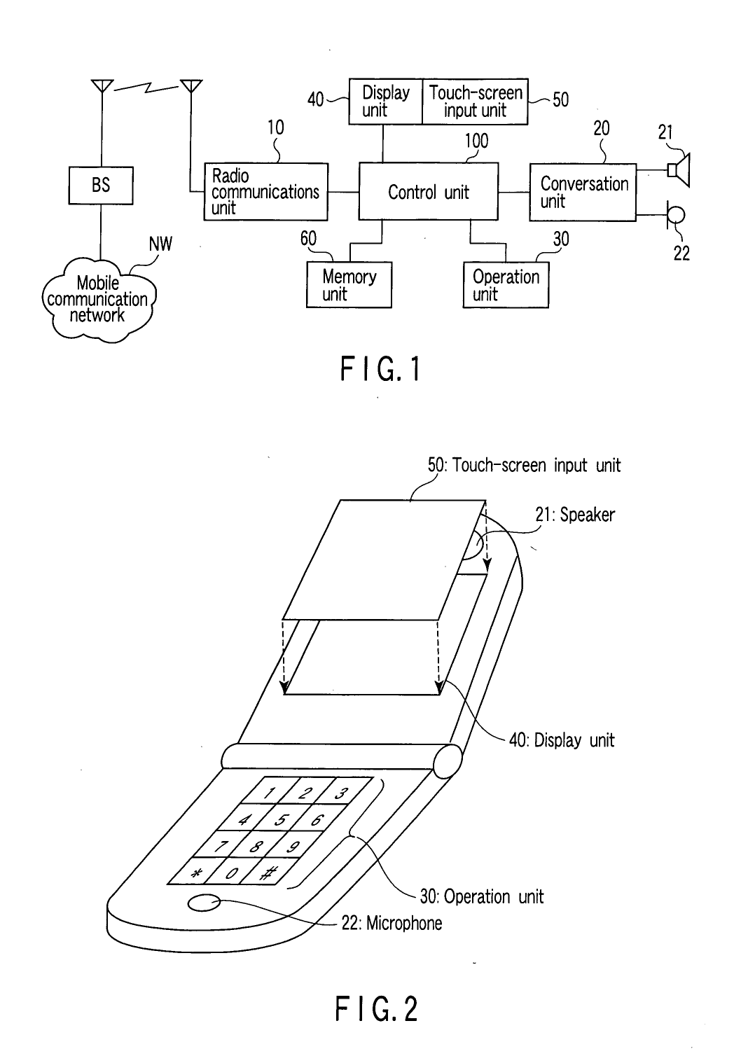

FIG. 2 shows an outer appearance of the mobile radio terminal. As shown in the figure, the touch-screen input unit 50 is mounted on the display face of the display unit 40. As the concrete detection method thereof, existing methods such as the resistant film method, the capacity method, optical sensor method, and the like can be applied, and the contact/non-contact and coordinate are detected by the methods.

The memory unit 60 stores the control data and control programs of the control unit 100, the application software such as the Web browser and the like, the address data in which names, telephone numbers and the like of the communication partners are associated with one another, the received and transmitted e-mail data, the Web data downloaded by Web browsing, the downloaded streaming data and the like.

The control unit 100 comprises a microprocessor, and makes operations under the control programs and control data stored in the memory unit 60 and controls all the units of the mobile radio terminal to implement speech and data communications. The control unit 100 also comprises a communication control function of making operations under the application software stored in the memory unit 60 and executing the transmission and reception of e-mail letters, Web browsing, control of the display of moving images based on downloaded streaming data and speech communications.

In addition, the control unit 100 comprises an input control function of displaying new information in the display area of the display unit 40, changing and displaying the information which has been already displayed in the display area, or accepting the user's request and executing, for example, the control to start communications, on the basis of the input information input from the touch-screen input unit 50.

Next, the operations of the mobile radio terminal having the above-described constitution are explained. In the following descriptions, the control operations concerning the communications such as speech communication, transmission and reception of e-mail letters, Web browsing and the like are not explained since they are the same as those of the prior art, but operations of touch input employing the touch-screen input unit 50 are particularly explained.

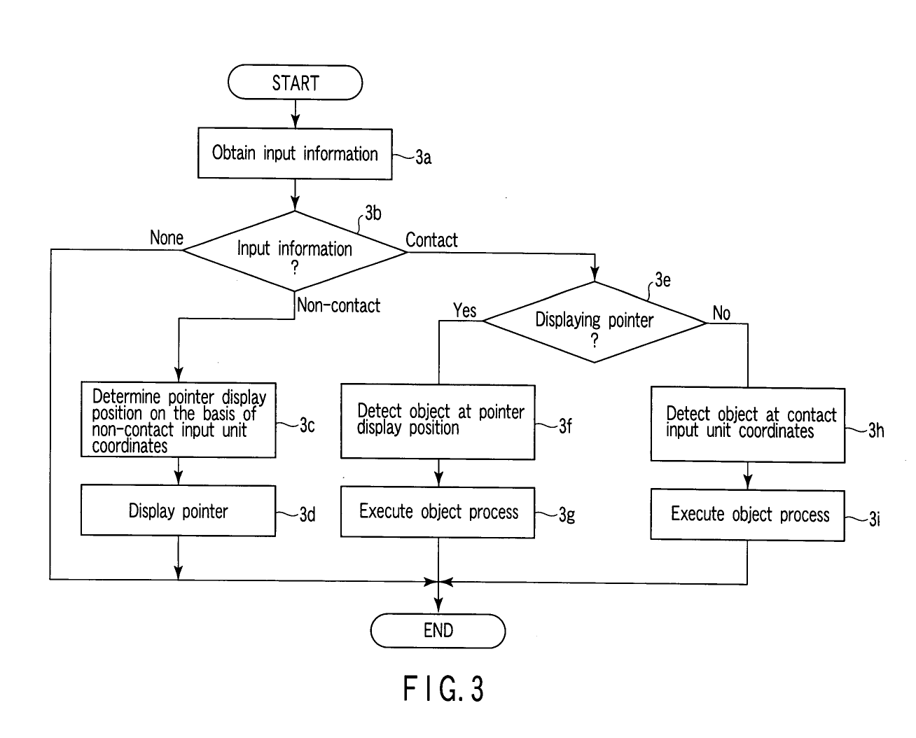

FIG. 3 is a flowchart showing operations of accepting the touch input from the user. When the power of the mobile radio terminal is turned on, the process shown in this figure is repeated in a preset scanning cycle by the control unit 100 until the power is turned off. The process is completed before a next scanning cycle. The control unit 100 implements the process shown in FIG. 3 by making operations under the control program stored in the memory unit 60.

First, in step 3a, the control unit 100 obtains the latest input information from the touch-screen input unit 50 when the scanning cycle has come. Then, the control unit 100 proceeds to step 3b. The latest non-contact input unit coordinates or contact input unit coordinates are thereby obtained, and the position of the stylus or finger which the user brings close to the touch-screen input unit 50 or which is made to contact the touch-screen input unit 50 by the user, is detected.

In step 3b, the control unit 100 discriminates the input information obtained in step 3a. If the control unit 100 cannot obtain the input information, i.e. if the user does not bring the finger or the like close to the touch-screen input unit 50 or does not make the finger or the like contact the touch-screen input unit 50, the control unit 100 ends this process and restarts the process in the next scanning cycle in step 3a.

If the obtained input information is the non-contact input unit coordinates, i.e. if the user does not make the finger or the like contact the touch-screen input unit 50 but brings the finger or the like close to the touch-screen input unit 50 and this matter is detected, the control unit 100 proceeds to step 3c. If the obtained input information is the contact input unit coordinates, i.e. if the user makes the finger or the like contact the touch-screen input unit 50 and this matter is detected, the control unit 100 proceeds to step 3e.

In step 3c, the control unit 100 determines the position of the pointer displayed in the display area of the display unit 40, on the basis of the non-contact input unit coordinates obtained in step 3a. Then, the control unit 100 proceeds to step 3d. The displayed position is determined to be a slightly upper position (for example, 32 dots) that is offset by a preset pixel content from the non-contact input unit coordinates, i.e. the position to which the user's finger or the like is brought most closely, to prevent the pointer from being hardly seen from the user due to the finger in a case where the pointer is displayed as it is at the position corresponding to the non-contact input unit coordinates.

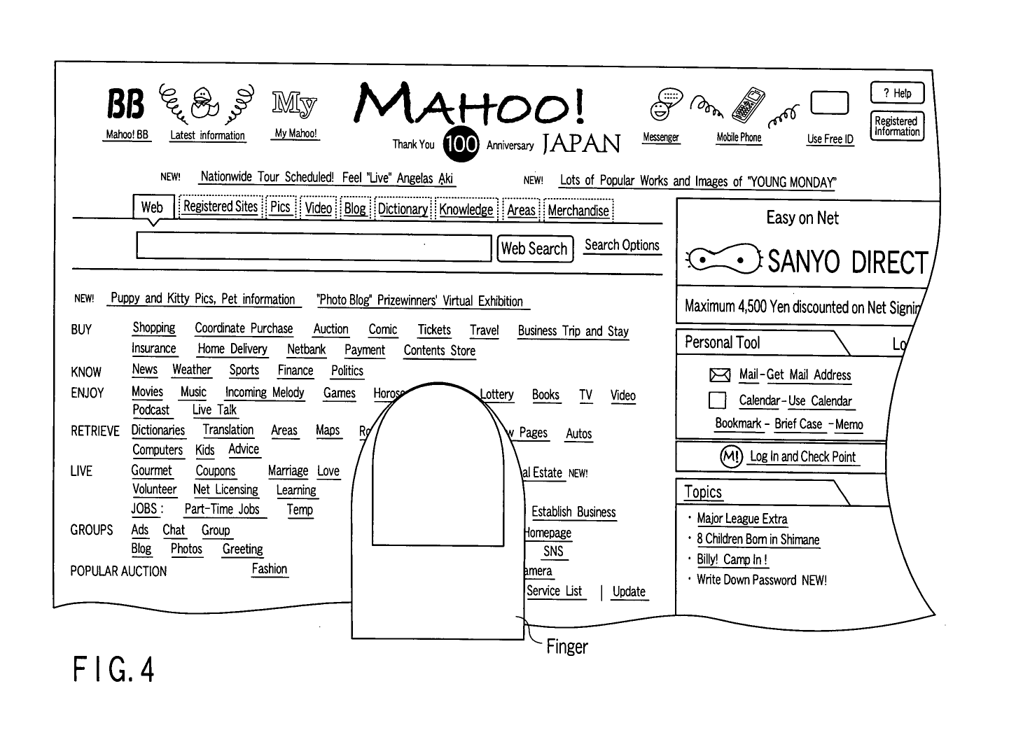

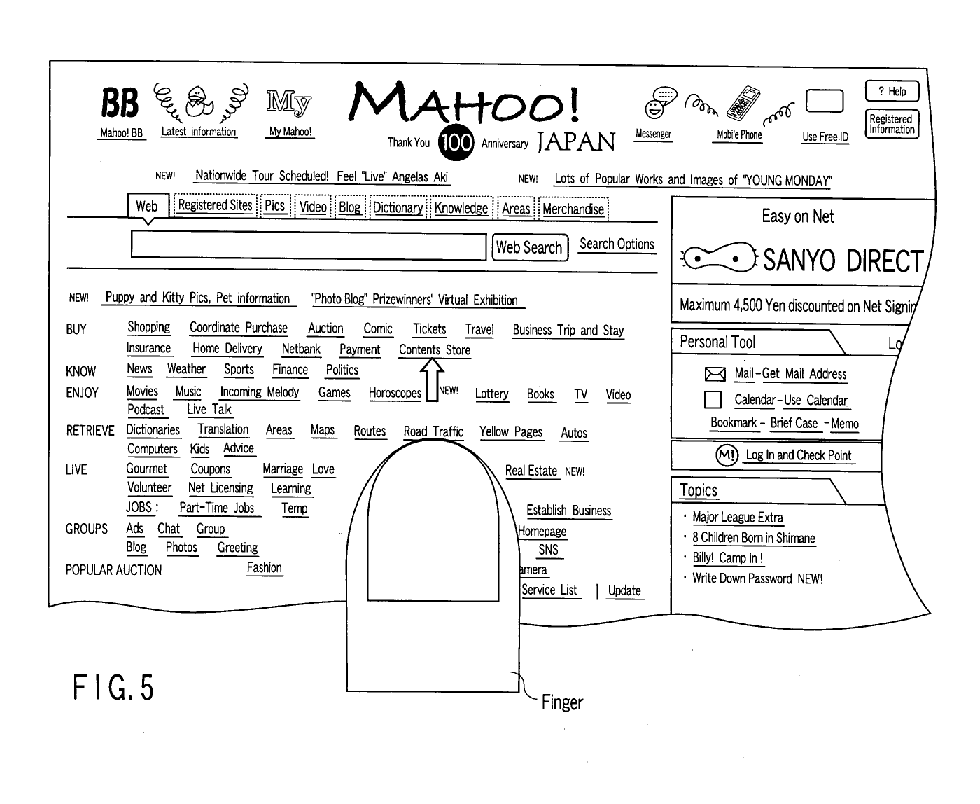

In step 3d, the control unit 100 controls the display unit 40 to display the pointer at the coordinates determined in step 3c, on the information which has already been displayed in the display area, and ends the process. Therefore, if the finger is brought close to the display unit 40 as shown in FIG. 4, for example, the pointer shaped in an arrow is displayed on the displayed information as shown in FIG. 5.

On the other hand, in step 3e, the control unit 100 discriminates whether or not the pointer has already been displayed. If the pointer has already been displayed, the control unit 100 proceeds to step 3f. If the pointer has not been displayed, the control unit 100 proceeds to step 3h.

In step 3f, the control unit 100 detects and selects the object displayed in the display area of the display unit 40, which is closest to the pointer, of the displayed information. The control unit 100 proceeds to step 3g.

In step 3g, the control unit 100 executes the process corresponding to the object selected in step 3f, and ends the process. In other words, if the process corresponding to the object is, for example, a shortcut of the application software, the control unit 100 executes the application software. For example, if a hyperlink is set, the control unit 100 executes the communication process to access the hyperlink. Instead of step 3f, step 3h and step 3i to be described below may be executed.

In step 3h, the control unit 100 detects the object displayed in the display area of the display unit 40 which is closest to the contact input unit coordinates. The control unit 100 proceeds to step 3i.

In step 3i, the control unit 100 executes the process corresponding to the object detected in step 3h, and ends the process. In other words, if the process corresponding to the object is, for example, a shortcut of the application software, the control unit 100 executes the application software. For example, if a hyperlink is set, the control unit 100 executes the communication process to access the hyperlink.

In the mobile radio terminal having the above-described configuration, if the user brings the finger or the like close to the display unit 40, the touch-screen input unit 50 detects the finger or the like and the pointer representing the position accepted by the control unit 100 is displayed in the display area of the display unit 40 and shown to the user.

Therefore, even if objects smaller than the finger are arranged closely to one another as shown in, for example, FIG. 5, the position where the user's instruction is accepted is represented by the pointer and the user can confirm the position of the pointer and confirm whether a desired position designation can be accepted. For this reason, since exact positioning can be executed by the relative movements and the exact instruction can be made, convenience in inputting can be enhanced.

In addition, if the finger is made to contact the touch-screen input unit 50 after the pointer is displayed, the process corresponding to the object which is closest to the pointer is executed irrespective of the contact position. Therefore, even if objects smaller than the finger are arranged closely to one another as shown in, for example, FIG. 5 and the desired object cannot be exactly pointed, the desired object can easily be selected and the execution of the process can be easily requested by the desired object.

Moreover, since the pointer is not displayed at the position corresponding to the non-contact input unit coordinates, but the position slightly upper than the position corresponding to the non-contact input unit coordinates, the pointer can be displayed at the position which is not covered by the finger but can be easily seen to the user and the high operability can be thereby obtained.

In the above-described embodiment, the object is selected by making the finger or the like contact the touch-screen input unit 50. If the pointer is displayed, the object selection may be accepted through the key input of the operation unit 30. In other words, when the confirmation instruction is executed by the key input of the operation unit 30 by bringing the finger or the like close to the touch-screen input unit 50 and displaying the pointer at the position where the desired object is selected, the control unit 100 selecting the confirmation instruction detects the object which is closest to the pointer and executes the process corresponding to the object as described in step 3f.

Next, the operations of the mobile radio terminal according to the second embodiment are explained. Since the mobile radio terminal of the second embodiment has the same configuration as that of the first embodiment shown in FIG. 1, the mobile radio terminal of the second embodiment is explained with reference to FIG. 1. The mobile radio terminal of the second embodiment is different from the mobile radio terminal of the first embodiment in terms of the control program of the control unit 100 stored in the memory unit 60.

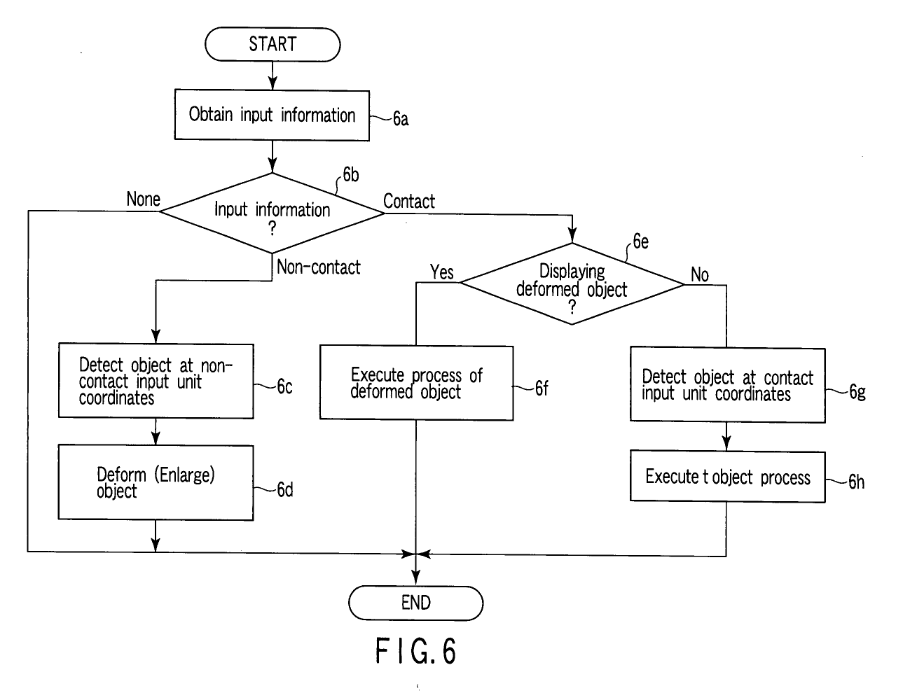

FIG. 6 is a flowchart showing operations of accepting the touch input from the user. When the power of the mobile radio terminal is turned on, the process shown in this figure is repeated in a preset scanning cycle by the control unit 100 until the power is turned off. The process is completed before a next scanning cycle. The control unit 100 implements the process shown in FIG. 6 by making operations under the control program stored in the memory unit 60.

First, in step 6a, the control unit 100 obtains the latest input information from the touch-screen input unit 50 when the scanning cycle has come. Then, the control unit 100 proceeds to step 6b. The latest non-contact input unit coordinates or contact input unit coordinates are thereby obtained, and the position of the stylus or finger which the user brings close to the touch-screen input unit 50 or which is made to contact the touch-screen input unit 50 by the user, is detected.

In step 6b, the control unit 100 discriminates the input information obtained in step 6a. If the control unit 100 cannot obtain the input information, i.e. if the user does not bring a finger thereof or the like close to the touch-screen input unit 50 or does not make the finger or the like contact the touch-screen input unit 50, the control unit 100 ends this process and restarts the process in the next scanning cycle in step 6a.

If the obtained input information is the non-contact input unit coordinates, i.e. if the user does not make the finger or the like contact the touch-screen input unit 50 but brings the finger or the like close to the touch-screen input unit 50 and this matter is detected, the control unit 100 proceeds to step 6c. If the obtained input information is the contact input unit coordinates, i.e. if the user makes the finger or the like contact the touch-screen input unit 50 and this matter is detected, the control unit 100 proceeds to step 6e.

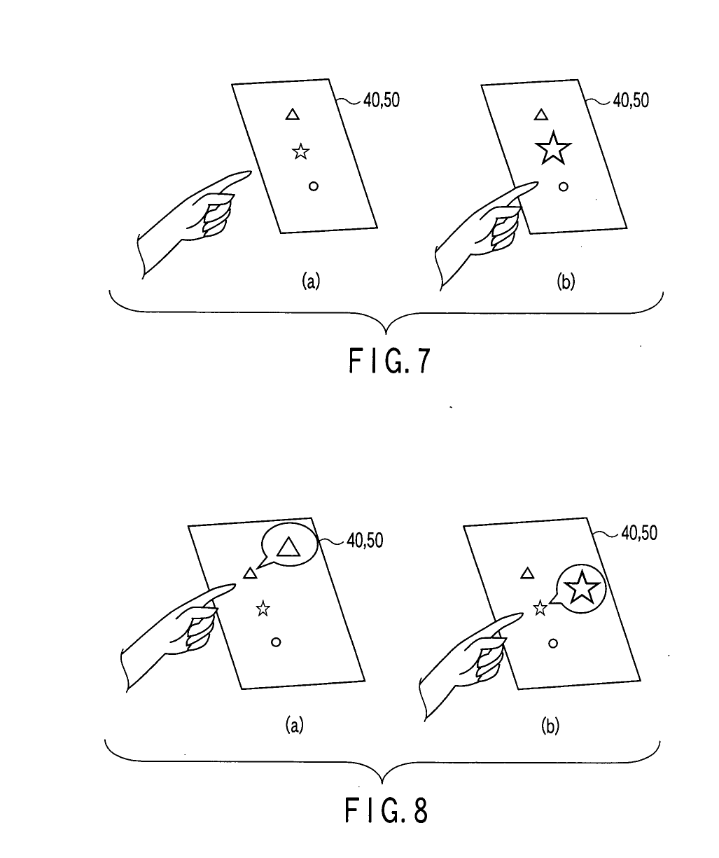

In step 6c, the control unit 100 detects the object displayed in the display area of the display unit 40, which is closest to the non-contact input unit coordinates obtained in step 6a. Then, the control unit 100 proceeds to step 6d. In step 6d, the control unit 100 controls the display unit 40 to deform and display the object detected in step 6c and inform the user that the object has been selected, and ends this process. For example, if the user brings the finger close to an object shaped in a star as shown in FIG. 7(b) while objects shown in FIG. 7(a) are displayed in the display area of the display unit 40, deformation such as enlargement, of the star-shaped object is executed by the touch-screen input unit 50 and control unit 100 detecting the finger.

On the other hand, in step 6e, the control unit 100 discriminates whether or not the object has already been deformed, i.e. whether or not the object has already been selected. If the object has already been selected, the control unit 100 proceeds to step 6f. If the pointer has not been displayed, the control unit 100 proceeds to step 6h.

In step 6f, the control unit 100 detects and selects the object which has already been deformed and displayed in the display area of the display unit 40, executes the process corresponding to the object, and ends this process. In other words, if the process corresponding to the object is, for example, a shortcut of the application software, the control unit 100 executes the application software. For example, if a hyperlink is set, the control unit 100 executes the communication process to access the hyperlink. Instead of step 6f, step 6g and step 6h to be described below may be executed.

In step 6g, the control unit 100 detects the object displayed in the display area of the display unit 40, which is closest to the contact input unit coordinates. The control unit 100 proceeds to step 6h.

In step 6h, the control unit 100 executes the process corresponding to the object detected in step 6g, and ends the process. In other words, if the process corresponding to the object is, for example, a shortcut of the application software, the control unit 100 executes the application software. For example, if a hyperlink is set, the control unit 100 executes the communication process to access the hyperlink.

In the mobile radio terminal having the above-described configuration, if the user brings the finger or the like close to the display unit 40, the touch-screen input unit 50 detects the finger or the like and the control unit 100 deforms (enlarges) the close object and displays the object in the display area of the display unit 40 for the user.

Therefore, even if objects smaller than the finger are arranged closely to one another as shown in, for example, FIG. 7, the object which accepts the instruction from the user is deformed and displayed, the user can confirm whether the desired object is selected, by confirming the deformed object. For this reason, since exact positioning can be executed by the relative movements and the exact instruction can be made, convenience in inputting can be enhanced.

In addition, if the finger is made to contact the touch-screen input unit 50 after the object is deformed (selected), the process corresponding to the deformed object is executed irrespective of the contact position. Therefore, even if objects smaller than the finger are arranged closely to one another as shown in, for example, FIG. 7 and the desired object cannot be exactly pointed, the execution of the process corresponding to the desired object can be easily requested.

In the above-described embodiment, the process of the deformed object is executed by making the finger or the like contact the touch-screen input unit 50. If the object is deformed, execution of the process of the object may be accepted through the key input of the operation unit 30. In other words, when the desired object is selected by bringing the finger or the like close to the touch-screen input unit 50 and confirmation instruction is executed by the key input of the operation unit 30, the control unit 100 detecting the confirmation instruction executes the process corresponding to the object as described in step 6f.

In the second embodiment, the selected object is enlarged, but the deformation is not limited to this. The color of the object may be changed to indicate that the object has been selected by the user. In addition, the selected object may not be deformed but additional display such as a balloon may be executed as shown in FIG. 8(a) and FIG. 8(b).

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, the process corresponding to the object is executed by the operations through the touch-screen input unit 50 and the operation unit 30. Instead of this, the control unit 100 may count the time when the user indicates the object and, after more than a certain period has passed, the corresponding process may be executed.

If the mobile radio terminal is put in a bag or the like, the input may be erroneously detected by the touch-screen input unit 50. To prevent such detection error, a sensor for detecting that the user contacts the mobile radio terminal or a camera for shooting an image of the user's face may be provided and, only when they detect the user's presence, the process shown in FIG. 3 and FIG. 6 may be executed.

In the above-described embodiments, application to the mobile radio terminal is described. However, the present invention is not limited to this and can also be applied to a portable information device such as PDA or the like. In addition, an input display device comprising a processor equipped with the control programs of the display unit 40, touch-screen input unit 50 and memory unit 60 can be constituted. By modularizing such an input display device, the present invention can be applied not only to the portable information device, but also to various kinds of information devices.

The present invention can be otherwise variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An input display apparatus, comprising:
a display unit which displays information;
a detection unit provided in a display area of the display unit to detect a position of an object brought close to the apparatus in an non-contact fashion, in the display area; and
a display control unit which displays information at a position based on the position detected by the detection unit, in the display area of the display unit.

2. The apparatus according to claim 1, wherein the display control unit displays at the position detected by the detection unit a pointer indicating the detected position.

3. The apparatus according to claim 2, wherein the detection unit detects contact of an object, and
the apparatus further comprises a selection unit which selects a displayed object closest to the pointer if the detection unit detects the contact while the display control unit displays the pointer.

4. The apparatus according to claim 1, wherein the display control unit displays a pointer at a position offset from the position detected by the detection unit in a preset distance.

5. The apparatus according to claim 4, wherein the detection unit detects contact of an object, and
the apparatus further comprises a selection unit which selects a displayed object closest to the pointer if the detection unit detects the contact while the display control unit displays the pointer.

6. The apparatus according to claim 5, further comprising an execution unit which executes a process corresponding to the object if the selection unit selects the object.

7. The apparatus according to claim 1, wherein the display control unit detects a displayed object closest to the position detected by the detection unit, deforms the object and displays the deformed object on the display unit.

8. The apparatus according to claim 7, wherein the detection unit detects contact of an object, and
the apparatus further comprises a selection unit which selects the object if the detection unit detects the contact while the display control unit deforms and displays the object.

9. The apparatus according to claim 8, further comprising an execution unit which executes a process corresponding to the object if the selection unit selects the object.

10. The apparatus according to claim 1, wherein the display control unit detects a displayed object closest to the position detected by the detection unit, adds information to the object and displays the object.

11. The apparatus according to claim 10, wherein the detection unit detects contact of an object, and
the apparatus further comprises a selection unit which selects the object if the detection unit detects the contact while the display control unit adds the information to the object and displays the object.

12. The apparatus according to claim 11, further comprising an execution unit which executes a process corresponding to the object if the selection unit selects the object.

13. A mobile radio terminal establishing radio communications with a base station accommodated in a network, comprising:
a display unit which displays information;
a detection unit provided in a display area of the display unit to detect a position of an object brought close to the apparatus in an non-contact fashion, in the display area; and
a display control unit which displays information at a position based on the position detected by the detection unit, in the display area of the display unit.

14. The apparatus according to claim 13, wherein the display control unit displays at the position detected by the detection unit a pointer indicating the detected position.

15. The apparatus according to claim 14, wherein the detection unit detects contact of an object, and
the apparatus further comprises a selection unit which selects a displayed object closest to the pointer if the detection unit detects the contact while the display control unit displays the pointer.

16. The apparatus according to claim 13, wherein the display control unit displays a pointer at a position offset from the position detected by the detection unit in a preset distance.

17. The apparatus according to claim 16, wherein the detection unit detects contact of an object, and
the apparatus further comprises a selection unit which selects a displayed object closest to the pointer if the detection unit detects the contact while the display control unit displays the pointer.

18. The apparatus according to claim 17, further comprising an execution unit which executes a process corresponding to the object if the selection unit selects the object.

19. The apparatus according to claim 13, wherein the display control unit detects a displayed object closest to the position detected by the detection unit, deforms the object and displays the deformed object on the display unit.

20. The apparatus according to claim 19, wherein the detection unit detects contact of an object, and
the apparatus further comprises a selection unit which selects the object if the detection unit detects the contact while the display control unit deforms and displays the object.

21. The apparatus according to claim 20, further comprising an execution unit which executes a process corresponding to the object if the selection unit selects the object.

22. The apparatus according to claim 13, wherein the display control unit detects a displayed object closest to the position detected by the detection unit, adds information to the object and displays the object.

23. The apparatus according to claim 22, wherein the detection unit detects contact of an object, and
the apparatus further comprises a selection unit which selects the object if the detection unit detects the contact while the display control unit adds the information to the object and displays the object.

24. The apparatus according to claim 23, further comprising an execution unit which executes a process corresponding to the object if the selection unit selects the object.
